(19) United States
(12) Patent Application Publication
(10) Pub. No.: US 2016/0297508 A1
(43) Pub. Date: Oct. 13, 2016

(54) METHOD FOR MANAGING THE SPEED OF A VESSEL

(71) Applicant: Sercel, Carquefou (FR)

(72) Inventor: Didier Renaud, Nantes (FR)

(21) Appl. No.: 14/681,799

(22) Filed: Apr. 8, 2015

(51) Int. Cl. B63H 23/28; G05D 1/02; G01V 1/38

(52) U.S. Cl. CPC B63H 23/28; G01V 1/3808; G05D 1/0206

(57) ABSTRACT

A method for managing the speed of at least one first vessel in a seismic survey. The first vessel sails at a current speed and performing a series of shots according to a predefined set of shot points, called preplot. The method includes, during at least a part of said seismic survey, computing an updated speed for the first vessel, using at least a time prediction shift defined as a time difference between at least: a raw time prediction for the first vessel, the raw time prediction being defined by the time to reach a shot point based on the current speed of the first vessel, and a corrected time prediction, for the first vessel, depending on at least one parameter related to at least one vessel of the seismic survey. Any of the raw predictions being computed for a given shot point in the preplot and at least one of the time prediction shift are computed for a given shot point in the preplot.

### 1. FIELD OF THE DISCLOSURE

The field of the disclosure is that of marine seismic prospection, enabling to study the different layers of the earth crust.

More precisely, the disclosure relates to a method for managing the speed of a vessel during a marine seismic acquisition involving several vessels.

The disclosure can be applied notably to the oil prospecting industry (hydrocarbon exploration) using seismic method (sea oil survey), but can be of interest for any other field which requires a system performing geophysics data acquisition in a marine environment.

### 2. TECHNOLOGICAL BACKGROUND

To perform a marine seismic acquisition in a survey area, it is common to use seismic sources (like “air guns”, “vibratory sources”, . . . ) and seismic sensors. The sensors are housed in cables, called streamers (or acoustic linear antennas or seismic cables). Several streamers are used together to form an array of thousands of sensors. Sources are towed by one or several vessels, and streamers are towed by one or several vessels. A same vessel can tow both sources and streamers (i.e. can tow one or several streamers and one or several seismic sources).

To collect the geophysical data in the marine environment, the seismic sources are activated to generate single pulses or continuous sweep of energy. The signals generated by each source travels through the different layers of the earth crust and the reflected signals are captured by the sensors (hydrophones) housed in the streamers. By processing the signals captured by the hydrophones, geophysicists are able to achieve an imaging of the different layers of the earth crust.

A seismic source should shoot at a shot point (also referred to as “shot point”), defined by its geographical coordinates (latitude/longitude and/or easting northing). When the vessel reaches this shot point, the seismic source is activated and produces an explosion. The set of shot points of all seismic sources is called “preplot”.

The marine seismic acquisition is controlled and monitored by a navigation system (also referred to as INS, for “Integrated Navigation System”), which is onboard each vessel. Each INS of a vessel allows computing position of sensors and seismic sources and driving the vessel along its acquisition path, according to a predetermined preplot, and to activate seismic sources to perform seismic acquisition at desired shot points of the preplot.

The navigation system also determines the moment of firing a source for each shot point, according to the positions of the various system components. This moment of firing is referred to as “shot time”.

To further increase the quality of seismic imaging, the seismic surveys can be performed in a well-known “multi-vessel” survey performed by a plurality of vessels.

In a multi-vessel survey, it is common to select a specific vessel among the plurality of vessels and to refer it to as a “master vessel”. This master vessel is a reference vessel and the reference of time of each other vessels thanks to its INS. Each other vessel is referred to as “slave vessel” and is synchronized on the reference of time of the master vessel. Such “reference/master vessel” is thus the reference to compute proper position to other vessels.

So that the shooting order is complied, the various vessels must be synchronized. The shooting order of the sources is defined by the preplot and must be performed as close as possible to the geographic coordinates of the shot points specified in the preplot.

More precisely, a seismic source of a vessel should perform its shot at a target location called “Bull's Eye” (also noted “BE”), this target location being computed during the survey from the reference vessel's positions. Each vessel, or more precisely the seismic source, has to match as possible this target location at the right time. In practice, a point of the reference vessel (or of any equipment associated with the reference vessel, e.g. a source) is used as reference point to calculate the ideal position of other vessels, i.e. for space synchronization of the vessels.

In the following description, it is assumed to describe a multi-vessel survey with one master vessel which is the reference vessel and at least one other vessels of the fleet, also referred to as “slave vessels”.

In such a configuration, a Bull's Eye of a slave vessel represents the ideal position where said slave vessel (or seismic source of a slave vessel) should be to perform its shot, said Bull's Eye being defined by a circular target having:
a center, called Bull's Eye Position, which depends on the projection of the master vessel's reference point on a sail line of the slave vessel, a sail line being the way to follow by a vessel to perform its preplot. In the particular case where the slave vessels are supposed to be aligned with the master vessel, the center of the “Bull's Eye” is coincident with the projection of the master vessel's reference point on the sail line of the slave vessel. In the particular case where the slave vessels are not supposed to be aligned, there is a predetermined offset, along the sail line of the slave vessels, between the center of the slave vessel's “Bull's Eye” and the projection of the master vessel's reference point on the sail line of the slave vessels; and
a radius of tolerance which can be determined by contract requirements (e.g. 10 m).

A reference point of the slave vessel (i.e. a seismic source) defined in advance, must be located in the “Bull's Eye” to ensure proper synchronization of said slave vessel.

A master vessel “Time to shot” (or “Shot Time TO” or “shooting time” or “master's vessel predictions”) is usually computed from:
master path and its shot points locations,
a distance between a shot point of the preplot and a master shot predict point location (master shot predict point is usually the air guns (sources) but can also be any other point owned by the master vessel),
master vessel speed along the path.

Usually, the “time to shot” for slave vessels is computed from a master vessel shooting time to ensure good shot scheduling. In other way, slave vessels can compute their own time to shot based on the master's vessel predictions.

To have a proper coverage, during a multi-vessel operation, each vessel has to be properly aligned to shot and record data, at the best location as possible. For that, it is necessary to control the vessels speed.

Usually, the master vessel computes speed order depending of its own sensors, and a slave vessel computes its speed relative from master's speed and master's position.

Thus, in a multi vessel configuration, there is a strong link with the reference vessel. This is a main disadvantage of this configuration. Indeed, if radio links are broken, slave vessels have no more the relative position of the master vessel. If the reference vessel has any issue and presents errors in its shots, the relative position of slave vessels will be “wrong” as they are based on a “wrong” master vessel's position. Moreover, if the master vessel has any issue and has to stop the line, slave vessels have to stop production even if they are able to continue.

Moreover, most of the other known systems are restrictive, as they work with relative positions. Indeed, in that case, all vessels must have the same kind of path (symmetric path, parallel path or the same path with an offset).

### 3. SUMMARY OF THE DISCLOSURE

A particular embodiment of the disclosure proposes a method for managing the speed of at least one first vessel in a seismic survey, said first vessel performing a series of shots according to a predefined set of shot points and sailing at a current speed, called preplot, wherein said method comprises, during at least a part of said seismic survey, computing an updated speed for said first vessel, using at least a time prediction shift defined as a time difference between at least:
a “time to reach a shot point” prediction, called a raw time prediction for said first vessel, and
a corrected time prediction, for said first vessel, depending on at least one parameter related to at least one vessel of said seismic survey,

a prediction being computed for a given shot point in said preplot

Thus, this particular embodiment relies on a wholly novel and inventive approach of the speed control of a vessel, in a multi-vessel survey or in a single vessel survey, ensuring that the vessel will shot at the proper time and the proper position without using relative speed and offset between vessels of the survey and without the need of a master vessel.

Indeed, this particular embodiment of the disclosure uses a time prediction shift to compute the updated speed of a first vessel, this time prediction shift being computing using some local parameters of the first vessel as well as parameters, in a multi-vessel survey, from other vessels involved in the survey. Thus taking into account the first vessel capacities and the behavior of other vessels optimizes the speed management of the first vessel.

The time prediction shift corresponds to the difference between a time to shot corrected by using some parameters from the vessel itself and/or other vessels, and a predicted time to shot, i.e. a time to shot computed from the first vessel parameters.

It is to be noted that this method, according to its different embodiments, is applied on a plurality, or all, the vessels in the survey (in case of multi-vessel survey), in order to ensure that all vessels will shot at the proper time and at the proper position.

According to a particular feature of the disclosure, computing the time prediction shift comprises, for said first vessel:
computing a series of raw time predictions of said first vessel using at least shot points locations and/or current speed and/or source position;
computing a series of corrected time predictions using at least said computed series of raw time predictions and/or at least remote raw time predictions from at least one distinct vessel of said survey and/or at least remote corrected time predictions from at least one vessel of said survey.

According to this first embodiment, the time prediction shift is computed from two series of predictions, for the first vessel, corresponding to the successive shot points related to the first vessel.

The first series of predictions corresponds to the time prediction, for each shot point related to the first vessel, obtained from the distance between the first vessel and the shot point location and from the first vessel current speed. The source position of the first vessel may also be used. This first series is called raw time predictions.

The second series of predictions corresponds to the time prediction, for each shot point related to the first vessel, obtained from the first vessel raw time prediction (previously computed) but also from other vessel(s) raw time predictions, called remote raw time predictions, and from other vessel(s) corrected time predictions, called remote corrected time predictions. These remote corrected time predictions correspond to the results obtained, for other vessel(s) of the survey, from the application of the proposed method for managing the speed, according to the different particular embodiments of the disclosure.

Thus, according to this first embodiment, the updated speed of the first vessel corresponds to the updated speed to ensure a proper coverage, taking into account its own capabilities as well as other vessels ones.

According to a particular embodiment of the disclosure, the method further comprises transmitting, to at least one second vessel of said survey, at least one of said parameters related to said first vessel:
said computed raw time predictions;
said computed corrected time predictions;
a safety status.

According to this particular embodiment, some of predictions computed for a first vessel are sent to one or many other vessels in the survey, for example all the vessels involved in the survey, in order for them to implement the proposed method of managing their own speed.

Thus, the proposed method of managing the speed of vessel may be implemented on all the vessels involved in the survey, so that all vessels will have an updated speed for an optimal coverage.

Moreover, some other parameters related to the first vessel may also be transmitted to other vessel(s), like a safety status, explained more in details below. This safety status is for example used, by the proposed method on other vessel(s) to compute their updated speed, taking account of the capabilities of the first vessel.

In particular, the method further comprises receiving by said first vessel, from at least one second vessel of said survey, at least one of said parameters related to said second vessel:
a raw time prediction;
a corrected time prediction;
a safety status.

According to this particular embodiment, the first vessel also receive parameters related to other vessels in the survey, for example all the other vessels involved in the survey, in order to adjust its updated speed to external constraints from other vessels.

For example, as already said, the corrected time predictions take into accounts some raw time prediction and corrected time prediction related to other vessels.

Moreover, as the first vessel sends its safety status to other vessel, it also receives some safety statuses from other vessels.

Thus, the updated speed of the first vessel takes also account of some capabilities of other vessels.

According to another embodiment of the disclosure, the method further comprises computing, for a given shot point in said preplot, at least an updated shot point location, called updated target location for said first vessel using said computed time prediction shift.

According to this particular embodiment, the target location may also be computed again, for the first vessel, as its updated computed speed may not be sufficient to ensure a proper coverage.

For example, the computing of an updated target location will ensure to correct an error in position of the source of the first vessel, while taking account of the acceleration and speed capabilities of the vessel, and the time prediction shift previously computed.

For example, computing said updated target location uses the trend, during time, of the curve representing said computed time prediction shift, for the first vessel, and some parameters related to the capabilities of said first vessel.

According to this particular embodiment, the updated target location, for a first vessel, is computed using the trend of the time prediction shift, previously computed and using some physical constraints limiting the vessel, as for example a maximum and a minimum speed, a maximum and a minimum acceleration . . . .

This way of computing the updated target location is described in more details in the patent application filed by the present Applicant, at the same date as the present patent application, and entitled “Method for managing the target location of a vessel”.

For example, said safety status is determined using at least one of the information related to the vessel:
predefined allowed speed range;
sensors values;
current speed;
current azimuth.

According to this particular embodiment, the safety status, for a first vessel, allows to take account of the capabilities of the first vessel by checking what is allowed for him regarding its speed in order that the computed updated speed respects speed range.

The safety status may also take account of the current azimuth of the vessel and its current speed, or any data relative to safety of the first vessel (obstacle . . . ).

According to a particular feature of the disclosure, computing the updated speed uses of at least one of the parameters:
minimum shot cycle time;
maximum shot cycle time;
minimum shot cycle time by vessel;
maximum shot cycle time by vessel;
tolerance zone;
predefined time range between some shots (if the predefined time range is null, then the shots are nearly simultaneous).

According to this particular embodiment, the proposed method of speed management also takes account of contractual constraints to compute the updated speed for a vessel, i.e. constraints not directly related to capabilities of the vessel or other vessels, but that need to be respected.

In particular, the method further comprises transmitting said computed updated speed to the vessel command and control navigation system.

According to this particular embodiment, the computed updated speed is sent to the vessel command and control navigation system, in order to be applied. Thus, the updated speed is taken into consideration and the updated vessel speed becomes the first vessel speed.

In particular, the method is implemented simultaneously on a plurality of vessels of said survey.

According to this particular embodiment, same process implementing the method of speed management according to the different embodiments of the disclosure runs in parallel on other vessels, thus ensuring that all vessels will navigate at its updated speed, and will shot at the proper time, at the proper position.

The disclosure further concerns a computer program product comprising program code instructions for implementing the above-mentioned method when said program is executed on a computer or a processor.

The disclosure also concerns a non-transitory computer-readable carrier medium storing a program which, when executed by a computer or a processor, causes the computer or the processor to carry out the above-mentioned method.

Another aspect of the disclosure concerns a seismic system comprising a first vessel involved in a seismic survey, sailing at a current speed and performing a series of shoots according to a predefined set of shot points, called preplot, said seismic survey comprising the following means for managing the speed of said first vessel, which are integrated in said first vessel and activated during at least a part of said survey:
means for computing an updated speed for said first vessel, using at least a time prediction shift defined as a time difference between at least:
   a “time to reach a shot point” prediction, called a raw time prediction for said first vessel, and
   a corrected time prediction, for said first vessel, depending on at least one parameter related to at least one vessel of said seismic survey,
a prediction being computed for a given shot point in said preplot.

Advantageously, the multi-vessel seismic system comprises means for implementing the steps of the above-mentioned method, in any of its different embodiments.

### 4. LIST OF FIGURES

Other features and advantages of embodiments of the disclosure shall appear from the following description, given by way of indicative and non-exhaustive examples and from the appended drawings, of which:

FIGS. 1a and 1b illustrate respectively a particular embodiment of the speed management method according to the disclosure;

FIG. 2 represents a curve associated to time prediction shift, along the time and a curve associated to time prediction shift taking account of some parameters related to first vessel, according to an embodiment of the disclosure;

FIG. 3 illustrates a flow diagram of a sub-process for computing the updated speed, according to the first embodiment of the speed management method of the disclosure;

FIGS. 4a and 4b illustrate the speed management method according to the disclosure, when a vessel in late;

FIGS. 5a and 5b illustrate the speed management method according to the disclosure, during an obstacle bypass for a vessel;

FIG. 6 illustrates a third example of a first embodiment the speed management method according to the disclosure, in a dogleg use case.

FIG. 7 illustrates a device included in an exemplary system of the disclosure.

### 5. DETAILED DESCRIPTION

The disclosure relates to a method for managing the speed of a vessel, in a seismic survey comprising a plurality of vessels, in order to ensure a proper coverage, during the survey involving those vessels, i.e. ensure that all vessels will shot at the proper time, at the proper position, without a strong link with a reference vessel. This allows a totally adaptive survey.

In fact, the method of the disclosure allows controlling the speed of the vessels on a time shift prediction, and no more on a master vessel.

In the following description, the embodiments are described in relation with a multi-vessel survey which comprises a reference vessel called “master vessel” and other vessels called “slave vessels”, each synchronization of each slave vessel depending on the master vessel's synchronization.

However, the case of a multi-vessel survey is not restrictive and the disclosure can be applied to a single vessel survey with only one vessel performs the seismic survey.

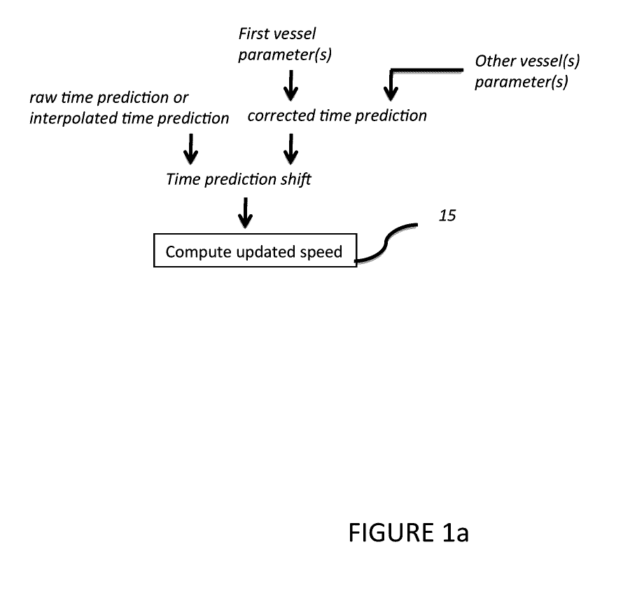

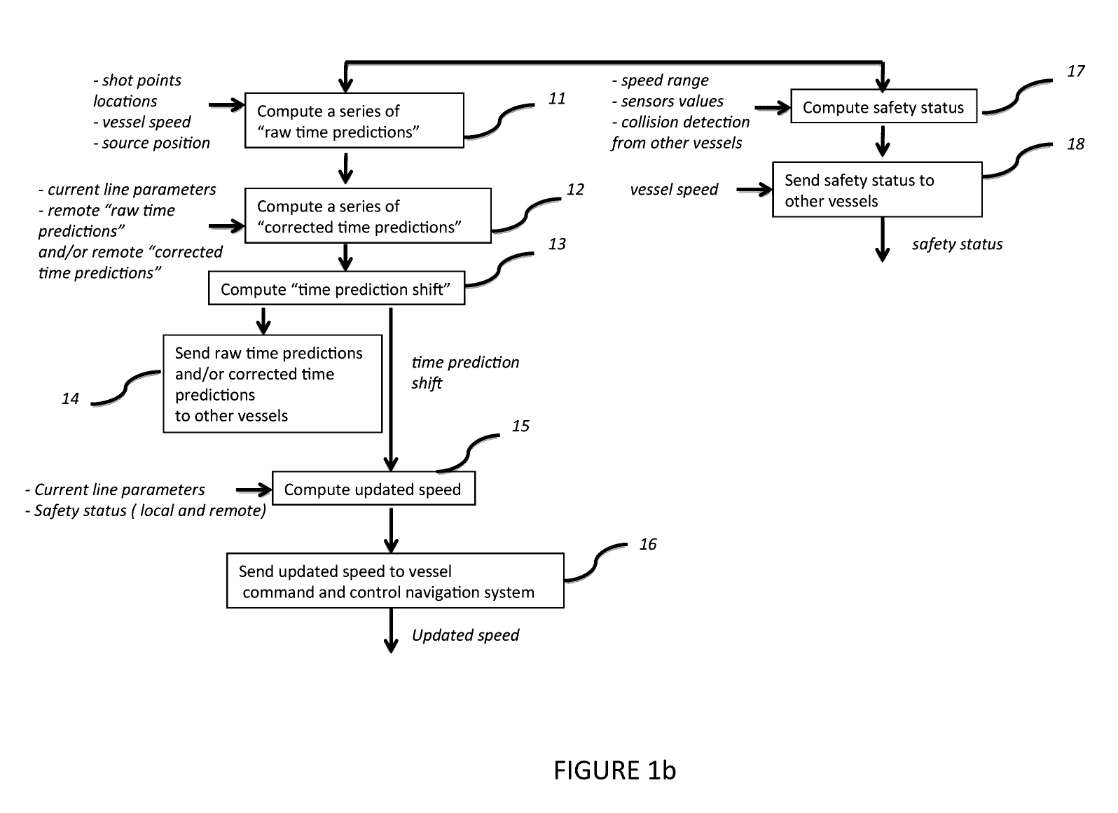

Referring now to FIG. 1a, we present a particular embodiment of the proposed speed management method for a vessel in a multi-vessel survey comprising a plurality of vessels.

According to this embodiment, the method comprises computing, in step 15, an updated speed of a first vessel, using a time prediction shift corresponding to a difference between a raw time prediction and a corrected time prediction.

These two time predictions are explained in more details in the following description.

According to this embodiment, the corrected time prediction takes account of other vessel(s) parameters of the survey. For example, the corrected time prediction takes account of parameters of all the other vessels involved in the survey.

Referring now to FIG. 1b, we present the particular embodiment of the proposed speed management method, wherein the time prediction shift is computed from a series of raw time predictions and a series of corrected time predictions.

It is to be noted that steps illustrated in FIG. 1b may be implemented in parallel on each vessel involved in the survey.

These steps are for example initiated by a timer loop, which typically runs continuously on each vessel during the survey. These steps can be split in two tasks, which are also running in parallel: a first task comprising steps 11 to 16, and a second task comprising steps 17 and 18.

First of all, in step 11, a series of “raw time predictions” is computed for a first vessel of the fleet, involved in the multi-vessel survey. A “raw time prediction” can be defined as the time at which the first vessel predicts to reach a planned shot point of a preplot, and a series of raw time predictions corresponds to the raw time prediction for each assigned shot point of the first vessel. These raw time predictions are computed from the distance between the first vessel and the shot points and from the vessel speed. The source position can also be used to compute a raw time prediction.

In step 12, a series of “corrected time predictions” is computed for a first vessel. A “corrected time prediction” can be defined as the time at which the first vessel will perform the shot, even if it is not properly located on the point location of a planned shot point, as a function of internal and external parameters of the first vessel, and a series of corrected time predictions corresponds to the corrected time prediction for each assigned shot point of the first vessel. More precisely, corrected time predictions are computed using:
first vessel raw time predictions, as computed in step 11,
remote raw time predictions coming from other vessels (for example the vessels involved in a multi-vessel survey),
remote corrected time predictions coming from other vessels, (for example the vessels involved in a multi-vessel survey),
“Minimum shot cycle time interval”, or “Min STI” corresponding to the minimum time that has to be respected between consecutives shots, on a same vessel, and/or between many vessels,
“Maximum shot cycle time interval”, or “Max STI” corresponding to the maximum time that has to be respected between consecutives shots, on a same vessel, and/or between many vessels,
“Tolerance zone”, which defines the tolerance area around the planned shot point location, where a shot is considered as valid,
“Shooting time slot”, typically based on a time division algorithm. Each vessel is allowed to shoot only in predetermined time windows. As example, with two vessels aligned on UTC time, one vessel will be able to shot in time windows [00,05], [20,25], [40,45], the other one in time windows [10,15], [30,35], [50,55].
Any other parameters that are used by the shooting predictions algorithm.

Then, in step 13, a “time prediction shift” is computed, for each shot point assigned to the first vessel, using at least the series of raw time predictions and the series of corrected time predictions previously computed.

In fact, the time prediction shift corresponds to the difference between a corrected time prediction, taking account of other vessels parameters (Min STI, Max STI, Tolerance zone, etc. . . . ) and/or its own parameters in a multi-vessel survey or only taking account of its own parameters in a single survey, and a raw time prediction depending only of the first vessel. Particularly in a multi-vessel survey, this computed time prediction shift allows aligning all the involved vessels by taking account of the shot errors, without using a master vessel as a reference. Basically, according to this embodiment, if:
the time prediction shift is negative, it means that the first vessel is late;
the time prediction shift is positive, it that the first vessel is ahead;
the time prediction shift has a huge negative value, it means that the first vessel is very late; and
the time prediction shift has a huge positive value, it means that the first vessel is far ahead other vessels.

Next, in step 14, the raw time predictions, computed in step 11, and the corrected time predictions, computed in step 12, are sent to other vessels (for example all or a part of all vessels involved in the survey), to be used as input of the same process that is running in parallel on other vessels.

In step 15, which may be implemented in parallel of step 14, the updated speed is computed, for the first vessel, using the time prediction shift delivered by step 13. Indeed, on the contrary to most of the known solutions (where the slave's vessel speed is computed from the reference vessel predictions), the updated speed is not computed here from a relative offset from the position of the master vessel, but from the trend of the time prediction shift.

Moreover, this way of controlling, which is independent from a master vessel, allows avoiding non-needed corrections, or wrong corrections, of the vessel speed based on wrong data in case of errors on the master shots.

As a conclusion, for a same shot point of the preplot, there is a difference of time to shoot, called a “time shift”, between a raw time prediction and a corrected time prediction.

The present disclosure proposes to use this time shift to foresee in a long term the position of a vessel, and thus to compute an updated speed for this vessel, allowing performing a seismic survey in a manner to avoid a strong link with a reference vessel as discussed above for a multi-vessel survey and ensuring that all vessels will shot at the proper time, at the proper position.

The method of the disclosure also allows controlling the vessels speed from corrected distances, as the relation between time and distance is known.

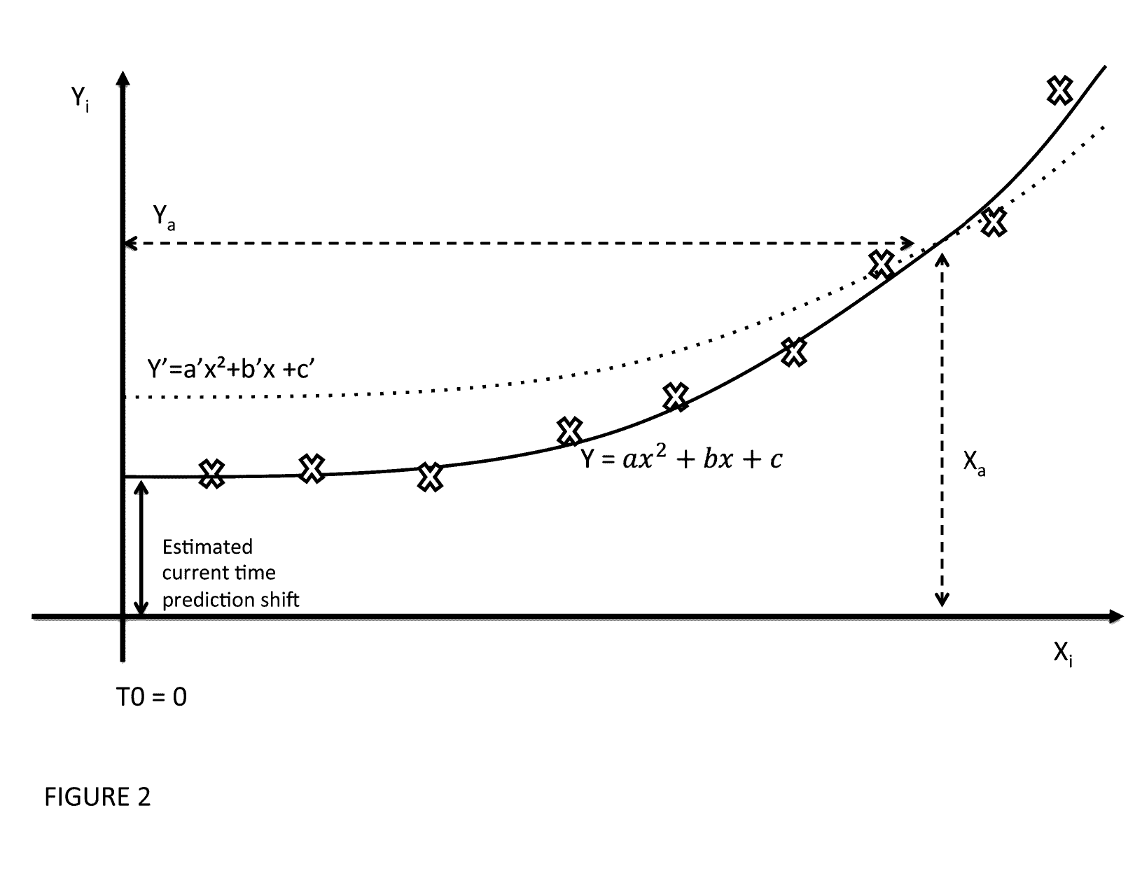

FIG. 2 illustrates a time prediction shift, called Yi, of a first vessel at a predictive time corresponding to the raw time prediction, called time Xi. In that case, the estimated time shift Yi is computed from a time prediction shift trend curve (in full line). This time prediction shift trend curve is built from time shifts at given Xi (for a given point of this curve, the time shift corresponds to the difference between the corrected time to shoot and the theoretical time to shoot defined in the preplot) and can be represented by the following equation:

Y=ax²+bx+c

where the parameters {a, b, c} can be (for example) resolved from a least square resolution algorithm based on the series of values {x,y}.

These parameters are usually used in the definition of second-degree polynomial corresponding to the interpolated curve, the aim being to obtain the trend curve from a linear regression, knowing the time shifts from the knowledge of constraints like the “Minimum shot cycle time interval”, the “Maximum shot cycle time interval”, the “Tolerance zone”, as described here above. For example, the parameters {a, b, c} are correlated with the following features: fixed difference, speed, and acceleration. “a” is expressed in 1/seconds, “b” has no dimension and “c” is expressed in seconds.

However, a vessel is limited by physical constraints, and the trend curve (in full line) illustrated in FIG. 2 and represented by the above equation Y=ax²+bx+c doesn't fit the capabilities of the vessel.

The other trend on FIG. 2, in dotted line, illustrates these capabilities of the vessel, and the time prediction shift trend curve that takes into account the physical limits of the vessel can be represented by the following equation:

Y′=a′x²+b′x+c′,

where the parameters a′ and b′ are limited by the current speed vessel Sc, the maximum and minimum speed values {Sₘᵢₙ, Sₘₐₓ} and the maximum and minimum acceleration values {Aₘᵢₙ, Aₘₐₓ}.

For example, Sc is the current speed of the vessel, at the time of computation and [0, Xₘₐₓ] is the time range of the raw time predictions series (from 0 to the last raw time predictions computed for the first vessel).

As (y+x)*Sc corresponds to the distance to shot, the relations between the different parameters a′, b′, a, b, Sₘᵢₙ, Sₘₐₓ, Aₘᵢₙ, Aₘₐₓ, Sc and Xₘₐₓ are defined by:

Aₘᵢₙ/(2*Sc)<a′<Aₘₐₓ/(2*Sc), and

(Sₘᵢₙ/Sc)−2*a′x−1<b′<(Sₘₐₓ/Sc)−2*a′*Sₘₐₓ−1

So typically, a′ will be equal to:

a if Aₘᵢₙ/(2*Sc)<a<Aₘₐₓ/(2*Sc),

Aₘᵢₙ/(2*Sc) if a<Aₘᵢₙ/(2*Sc),

Aₘₐₓ/(2*Sc) if a>Aₘₐₓ/(2*Sc).

Moreover, b′ will be equal to:

b if min(((Sₘᵢₙ/Sc)−(2*a′*Sₘₐₓ−1)),((Sₘᵢₙ/Sc)−1))<b<max(((Sₘₐₓ/Sc)−(2*a′*Sₘ−1)),((Sₘᵢₙ/Sc)−1)),

min(((Sₘᵢₙ/Sc)−(2*a′*−1)),((Sₘᵢₙ/Sc)−1)) if b<min(((Sₘᵢₙ/Sc)−(2*a′*Sₘ−1)),((Sₘᵢₙ/Sc)−1)),

max(((Sₘₐₓ/Sc)−(2*a′*S−1)),((Sₘₐₓ/Sc)−1)) if b>max(((Sₘₐₓ/Sc)−(2*a′*S−1)),((Sₘₐₓ/Sc)−1)).

Thus, if we consider that the updated speed OptS corresponds to the speed allowing the first vessel to reach a predicted shot point location “Pₐ” in a corrected time (Xₐ+Yₐ) (which corresponds to the time to reach a point P′ₐ different from Pₐ), thus the updated speed OptS is computed according to the following equation:

OptS=Sc*Xₐ/(Xₐ+Yₐ).

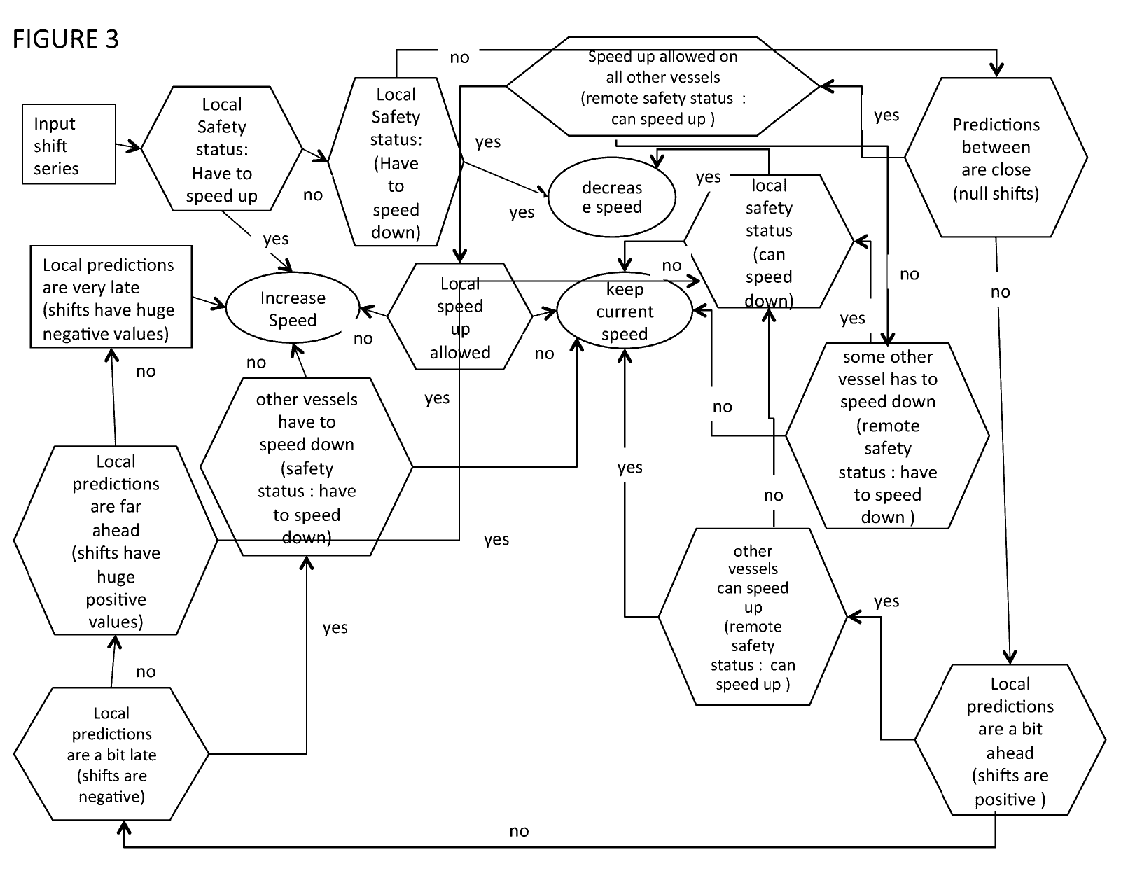

In a second implementation example, illustrated in FIG. 3, the computation of the updated speed OptS is based on logic or fuzzy logic, by comparing series of time prediction shifts for the next shots, in a multi-vessel survey. The benefit of this implementation is to take into account if other vessels are able to increase or decrease speed, and to adapt the decision depending on this.

For example, all the series of time prediction shifts are checked from the short-term (first shift of the series) to the long-term (last shift of the series), to decide if the raw time predictions are ahead or below the corrected time predictions. Thus, short-term average, but also mid-term and long-term average are take into account, allowing smooth and predictive estimation of the updated speed. Evolution from short-term, to mid-term, and long-term allows measuring the trend of the time prediction shift curve.

In an alternative embodiment, this updated speed computation can be implemented with linear, non-linear filtering or neuronal network . . . .

Coming back to FIG. 1b, the computed updated speed OptS for the first vessel is sent, in step 16, to its command and control navigation system, in order to modify the current speed of the first vessel. Then, the current vessel speed becomes the updated speed previously computed.

It is to be noted that, if the current speed vessel Sc is close to Sₘᵢₙ, Aₘᵢₙ can be increased dynamically from the configured value. Indeed, by definition, if the current speed vessel Sc is close to its maximum speed Sₘₐₓ, its maximum acceleration Aₘₐₓ is null.

In step 17, which may be implemented in parallel of steps 11 to 16 previously described, the safety status is computed, for the first vessel.

Basically, each vessel checks what is allowed for it, regarding its speed range, and a computed safety status may be one of the non-exclusive following ones:
Can speed up,
Can't speed up,
Can speed down,
Can't speed down,
Have to speed up,
Have to speed down,
Any combination of the preceding statuses (for example: Can speed up and can speed down).

These statuses are computed from speed, azimuth or any data relative to the safety of the first vessel, as for example:
Gun deployment modes, streamer deployment modes, and workboat operation. For each of these modes, user sets a predefined range of maximum and minimum speed;
Navigator (human) requirement, such as:
   Predefined allowed speed range [maximum speed, minimum speed] for vessel and/or any in sea equipment,
   Predefined allowed speed range [maximum speed, minimum speed] depending of event of navigation,
   Planned speed or speed range associated to the current navigated sail line,
   Basic order: keep current speed, keep a constant speed . . . .
Vessel shape versus other vessel shape or any moving obstacle shape and so relative speed, azimuth and ranges between vessels.
Any other data relative to safety and linked to vessel speed.

Next, in step 18, the safety status computed in step 17 is sent to other vessels (for example all a port of all vessels involved in the survey), to be used as input of the same process that is running in parallel on other vessels.

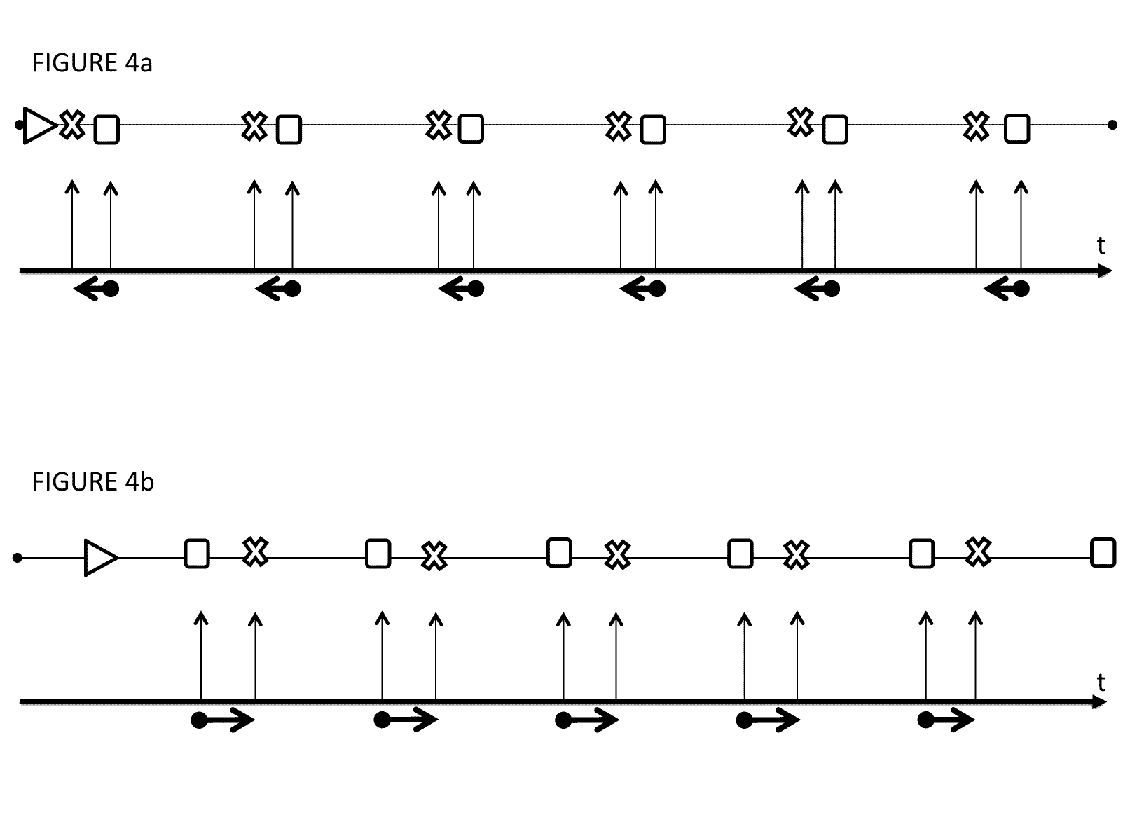

We refer now to FIGS. 4a, 4b, 5a, 5b and 6. In all these figures later described, a triangle represents a vessel on its path/sail line, a cross represents a predicted shot point, resulting from the corrected time prediction and a square represents a planned shot point, resulting from the raw time prediction. The arrow (pointing to the left or to the right) corresponds to the estimated time prediction shift Yᵢ.

Basically, the shooting management of vessels (for example in a multi-vessel survey), including the speed management, introduces errors in the shot point locations, if they are not well aligned, if they are too fast, too slow, . . . .

Ideally, the shooting management will thus also try to share the error between vessels. For example, a vessel late will shot at a position on its path that will be before the planned shot point. Thus, the corrected prediction time will be before its raw prediction time. In the same way, a vessel ahead other vessels will delay its corrected prediction time from its raw prediction time.

Referring now to FIGS. 4a and 4b, we present the time prediction shifts respectively for two vessels resulting from the error in position due to the late of the first vessel (FIG. 4a), the time prediction shift being negative for this first vessel. On the contrary, the time prediction shift being positive for the second vessel (FIG. 4b), this vessel is ahead. Thus, the first vessel needs to shoot before its planned shot time and the second vessel needs to delay its shot, in order to provide for a proper cover for the survey.

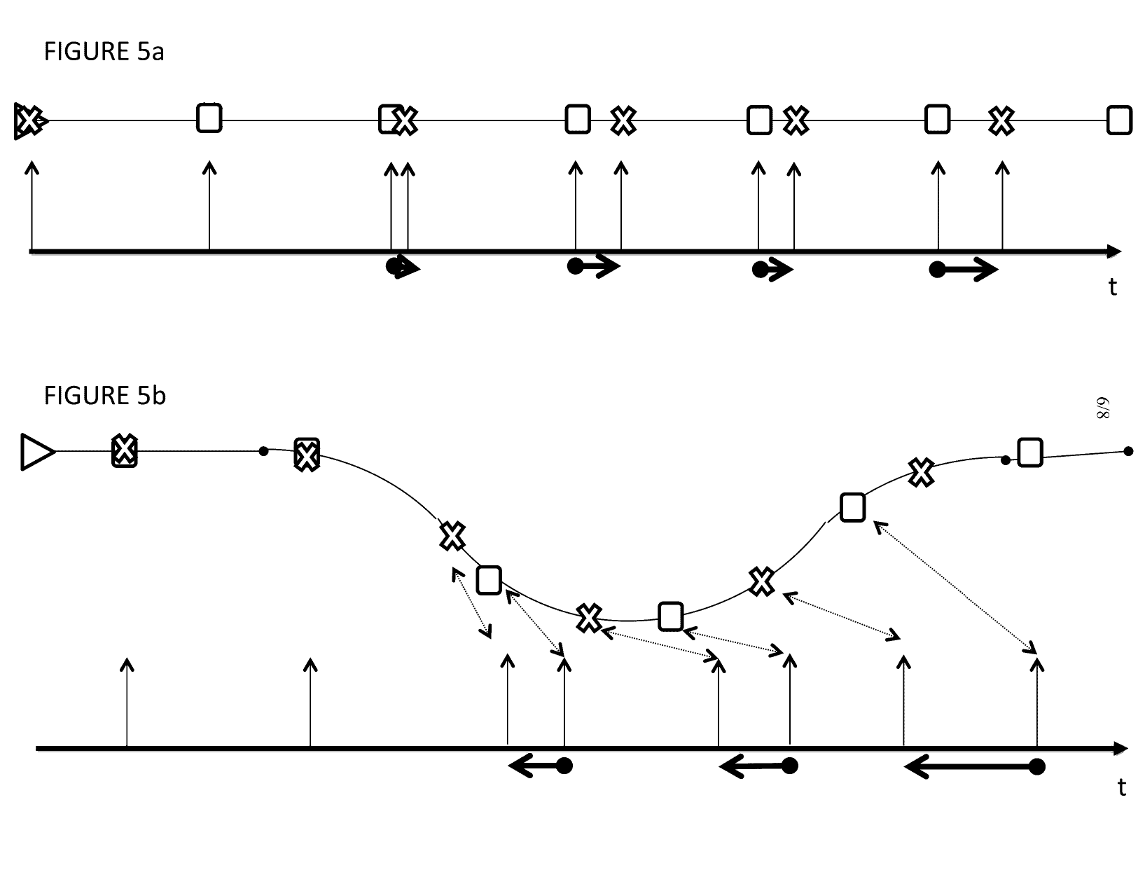

Referring now to FIGS. 5a and 5b, we present the time prediction shifts respectively for two vessels resulting from the error in position, during an obstacle bypass for the second vessel (FIG. 5b). In that case, the first vessel is neither late nor ahead, but will need to correct its shooting time in order to take account of the obstacle bypass of the second vessel. Indeed, as the second vessel will have a modified path, it cannot respect its raw prediction time. Thus, as illustrated on FIG. 5a, the first vessel will delay its shots (the time prediction shift being positive) and the second vessel will shot before its planned shot times (the time prediction shift being negative) during the bypass of the obstacle by the second vessel.

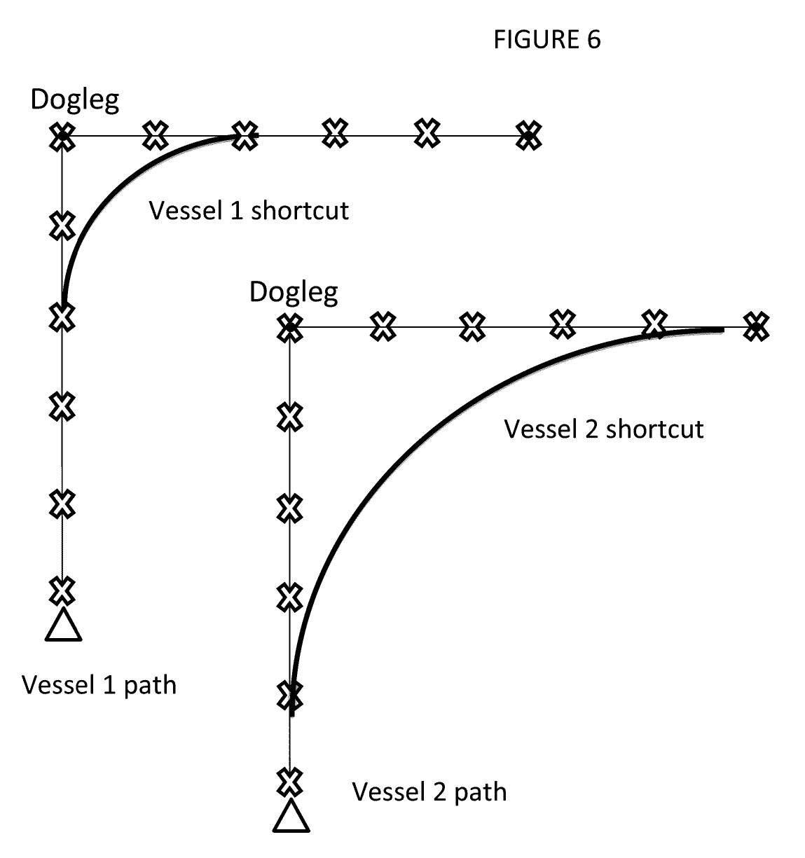

Referring now to FIG. 6, a well-known vessel pattern “dogleg” use case is illustrated, wherein the two vessels can't follow the defined path, due to their capacities (which may differ depending on the vessel). Thus, as illustrated, vessels steer shortcut. In that case, the two vessels are perfectly aligned, with the same speed.

According to most of the known solutions, a speed management based on the relative positions and the current speed of the two vessels won't change speed at the beginning and will create discontinuous output speed control command, when the vessel will reach the dogleg.

On the contrary, a speed management according to the different embodiments of the disclosure, that takes into account the vessels positions along the shortcut to compute series of time prediction to reach a point, especially long-term prediction, will smooth and anticipate output for speed management, by computing the updated speed of each vessel, regardless of the relatives positions of the vessels.

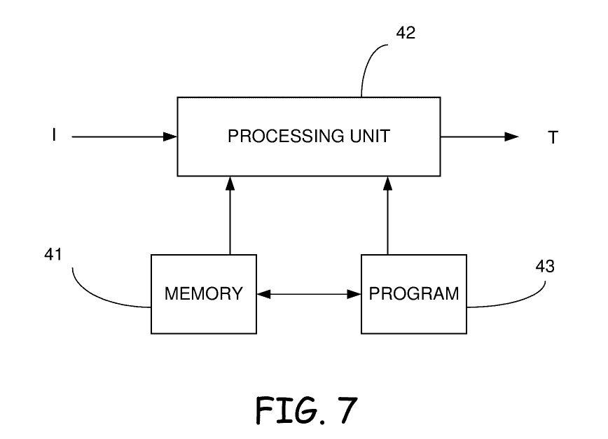

FIG. 7 illustrates a device included in a system according to the disclosure. For example, the device comprises a memory 41 constituted by a buffer memory, a processing unit 42 equipped for example with a microprocessor, and driven by the computer program 43 implementing the acts of a method for managing the speed of at least one vessel in a seismic survey as described herein. At initialization, the code instructions of the computer program 43 are for example loaded into a memory and then executed by the processor of the processing unit 42. The processing unit 42 inputs for example a speed. The microprocessor of the processing unit 42 implements the acts of the method according to the instructions of the computer program 43 to control the speed. This device comprises part or all of means described for implementing the proposed method. The device thus comprises for example the following means for managing the speed of a first vessel. The device is for example integrated in the first vessel and activated during at least a part of said survey:
means for computing an updated speed for said first vessel, using at least a time prediction shift defined as a time difference between at least:
   a “time to reach a shot point” prediction, called a raw time prediction for said first vessel, and
   a corrected time prediction, for said first vessel, depending on at least one parameter related to at least one vessel of said seismic survey,
a prediction being computed for a given shot point in said preplot

The disclosure, in at least one embodiment, is aimed especially at overcoming the above-described different drawbacks of the prior art.

More specifically, at least one embodiment of the disclosure provides a method and a system for ensuring that all vessels will shot at the proper time, at the proper position, for example in a multi-vessel survey, without a strong link with a reference vessel.

At least one embodiment of the disclosure provides a method and a system of this kind, which minimizes the exploration time on a survey, thus minimizing fuel consumption.

At least one embodiment of the disclosure provides a method and a system of this kind, which respects customer specific requirement as mammal regulation such as maximum shot cycle time/maximum shot cycle time by vessel, minimum shot cycle time, nearly simultaneous shooting, and predefined time delay between some shots (these last terms are more detailed later on the description).

At least one embodiment of the disclosure provides a method and a system of this kind, which enables a predictive behavior and a tolerance to irregular preplots.

At least one embodiment of the disclosure provides a method and a system of this kind, which provides for a reliable multi-vessel survey, able to work with poor quality radio links.

At least one embodiment of the disclosure provides a method and a system of this kind that is simple to implement and inexpensive.

Although the present disclosure has been described with reference to one or more examples, workers skilled in the art will recognize that changes may be made in form and detail without departing from the scope of the disclosure and/or the appended claims.

What is claimed is:

1. A method for managing the speed of at least one first vessel in a seismic survey involving at least one vessel, said first vessel sailing at a current speed and performing a series of shots according to a predefined set of shot points, called preplot, wherein said method comprises:
during at least a part of said seismic survey, computing an updated speed for said first vessel, using at least a time prediction shift defined as a time difference between at least:
a raw time prediction for said first vessel, said raw time prediction being defined by the time to reach a shot point based on the current speed of said first vessel, and
a corrected time prediction, for said first vessel, depending on at least one parameter related to at least one vessel involved in said seismic survey,
any of the raw predictions being computed for a given shot point in said preplot and at least one of the time prediction shift being computed for a given shot point in said preplot.

2. The method for managing the speed of a first vessel according to claim 1, wherein computing the time prediction shift comprises, for said first vessel:
computing a series of raw time predictions of said first vessel using at least shot points locations and/or current speed and/or source position;
computing a series of corrected time predictions using at least said computed series of raw time predictions and/or at least remote raw time predictions from at least one vessel of said survey and/or at least remote corrected time predictions from at least one vessel of said survey.

3. The method for managing the speed of a first vessel according to claim 2, wherein the method further comprises transmitting, to at least one second vessel of said seismic survey, at least one of the following parameters related to said first vessel:
said computed raw time predictions;
said computed corrected time predictions;
a safety status.

4. The method for managing the speed of a first vessel according to claim 1, wherein the method further comprises receiving by said first vessel, from at least one second vessel of said seismic survey, at least one of the following parameters related to said second vessel:
a raw time prediction;
a corrected time prediction;
a safety status.

5. The method for managing the speed of a first vessel according to claim 1, wherein the method further comprises computing, for a given shot point of said preplot, at least an updated shot point location, called updated target location, for said first vessel using said computed time prediction shift.

6. The method for managing the speed of a first vessel according to claim 5, wherein computing said updated target location uses the trend, during time, of the curve representing said computed time prediction shift, for the first vessel, and some parameters related to the capabilities of said first vessel.

7. The method for managing the speed of a first vessel according to claim 3, wherein said safety status is determined using at least one of the following information related to the first vessel:
predefined allowed speed range;
sensors values;
current speed;
current azimuth.

8. The method for managing the speed of a first vessel according to claim 1, wherein computing the updated speed uses at least one of the following parameters:
minimum shot cycle time;
maximum shot cycle time;
minimum shot cycle time by vessel;
maximum shot cycle time by vessel;
tolerance zone;
predefined time range between some shots.

9. The method for managing the speed of a first vessel according to claim 1, further comprising transmitting said computed updated speed to a vessel command and control navigation system.

10. The method according to claim 1, further comprising managing the speed of a fleet of vessels wherein the speed of each vessel is managed according to the method of claim 1.

11. A non-transitory computer-readable carrier medium storing a computer program comprising program code instructions for implementing a method for managing the speed of a first vessel in a seismic survey involving at least one vessel, when said program is executed on a computer or a processor, said first vessel sailing at a current speed and performing a series of shots according to a predefined set of shot points, called preplot, wherein said method comprises:
during at least a part of said seismic survey, computing an updated speed for said first vessel, using at least a time prediction shift defined as a time difference between at least:
a raw time prediction for said first vessel, said raw time prediction being defined by the time to reach a shot point based on the current speed of said first vessel, and
a corrected time prediction, for said first vessel, depending on at least one parameter related to at least one vessel involved in said seismic survey,
any of the raw predictions being computed for a given shot point in said preplot and at least one of the time prediction shift being computed for a given shot point in said preplot.

12. A seismic system comprising:
a first vessel involved in a seismic survey, configured to sail at a current speed and perform a series of shoots according to a predefined set of shot points, called preplot; and
the following means for managing the speed of said first vessel, which are integrated in said first vessel and activated during at least a part of said survey:
means for computing an updated speed for said first vessel, using at least a time prediction shift defined as a time difference between at least:
a raw time prediction for said first vessel, said raw time prediction being defined by the time to reach a shot point based on the current speed of said first vessel, and
a corrected time prediction, for said first vessel, depending on at least one parameter related to at least one vessel involved in said seismic survey,
any of the raw predictions being computed for a given shot point in said preplot and at least one of the time prediction shift being computed for a given shot point in said preplot.

13. The seismic system according to claim 12 comprising a plurality of vessels.

14. The method for managing the speed of a first vessel according to claim 4, wherein said safety status is determined using at least one of the following information related to the first vessel:
predefined allowed speed range;
sensors values;
current speed;
current azimuth.
